(19) United States
(12) Patent Application Publication
(10) Pub. No.: US 2016/0082298 A1
(43) Pub. Date: Mar. 24, 2016

(54) Forest Fire Control System

(71) Applicant: William Kelly Dagenhart, Oak Ridge, TN (US)

(72) Inventor: William Kelly Dagenhart, Oak Ridge, TN (US)

(21) Appl. No.: 14/858,469

(22) Filed: Sep. 18, 2015

Related U.S. Application Data
(60) Provisional application No. 62/052,605, filed on Sep. 19, 2014.

(51) Int. Cl. A62C 3/02; A62C 37/36

(52) U.S. Cl. CPC A62C 3/025; A62C 37/36

(57) ABSTRACT

A system and method for locating and suppressing a forest fire in the beginning stage comprising a fire location means such as one or more unmanned drones, a processing and control means configured to control the drones, to process location and other information about the forest fire, to develop a fire suppression proposal and to control a delivery means, a delivery means such as a guided missile system, and a fire suppression means such as a missile containing fire retarding chemicals.

### CROSS-REFERENCE TO RELATED APPLICATIONS

This application claims the benefit of U.S. Provisional Patent Application No. 62/052,605, filed on Sep. 19, 2014, which is incorporated herein in its entirety by reference.

### STATEMENT REGARDING FEDERALLY-SPONSORED RESEARCH OR DEVELOPMENT

Not Applicable

### BACKGROUND OF THE INVENTIVE CONCEPT

1. Field of Invention

The present general inventive concept relates to a system and a method for locating, suppressing, and extinguishing a forest fire in the beginning stage.

2. Description of the Related Art

A forest fire can burn a very large area of forest in a very short time and threaten residential and commercial areas near the forest. A large forest fire will likely result in large fire-fighting costs and other economic losses and endanger wildlife and humans. Four elements are needed to start and sustain a fire: (1) fuel, (2) heat or other ignition source, (3) oxygen, and (4) chemical reaction. Various methods of fighting forest fires are known in the art.

One common method of fighting a fire is to spray water on the fire with a hose fed by a water main, a water tanker, a lake, or a stream to cool the fire, thus removing the element of heat. The water may also dilute the oxygen in the air around the fire when the water is converted into water vapor. A helicopter or an airplane may be used to drop large amounts of water on the fire. Another method of fighting forest fires is to remove the fuel by removing undergrowth and trees in the fire's path or by back-burning an area in front of the fire. A liquid, foam, or solid chemical flame retardant may be sprayed or dropped on a fire to interrupt the chemical chain reaction. The chemical may react with the fuel to stop combustion or it may form a blanket that separates the oxygen in the air from the fuel.

The foregoing methods are typically utilized once the fire has been located and personnel or equipment have arrived at the site of the fire. The delay in locating and delivering a response to suppress and extinguish the fire often results in the forest fire burning a large area before the fire can be brought under control. A system and a method are needed that can immediately locate a new forest fire and quickly deliver a response to suppress and extinguish the forest fire in its beginning stage.

### BRIEF SUMMARY OF THE PRESENT INVENTIVE CONCEPT

The present general inventive concept provides a system for locating, suppressing, and extinguishing a forest fire in the beginning stage, comprising: (a) a fire locating means such as one or more unmanned drones configured to detect and locate a new forest fire, (b) a processing and control means such as a computer with computer software applications configured to process location and other information about the new forest fire, to develop a fire suppression proposal, and to control a delivery means, (c) a delivery means such as a guided missile system configured to deliver a fire suppression means to the location of the forest fire, and (d) a fire suppression means such as a missile configured to contain fire retarding chemicals to suppress and extinguish the fire.

The present general inventive concept also provides a method for locating, suppressing, and extinguishing a forest fire in the beginning stage, comprising: (a) detecting and locating a new forest fire, (b) processing location and other information about the new forest fire, developing a fire suppression proposal, and controlling a delivery means, (c) delivering fire retardants to the location of the forest fire, and (d) suppressing and extinguishing the forest fire.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is diagram illustrating one example embodiment of a forest fire control system configured to quickly locate, suppress, and extinguish a new forest fire in the beginning stage; and

FIG. 2 is diagram illustrating another example embodiment of a forest fire control system utilizing a drone, a control system, a ballistic missile delivery system, and a GPS-guided missile containing a fire retarding chemical.

### DETAILED DESCRIPTION OF THE INVENTIVE CONCEPT

Reference will now be made to an example embodiment of the present general inventive concept, an example of which is illustrated in the accompanying drawings and illustrations. The example embodiment is described herein in order to explain the present general inventive concept by referring to the figures.

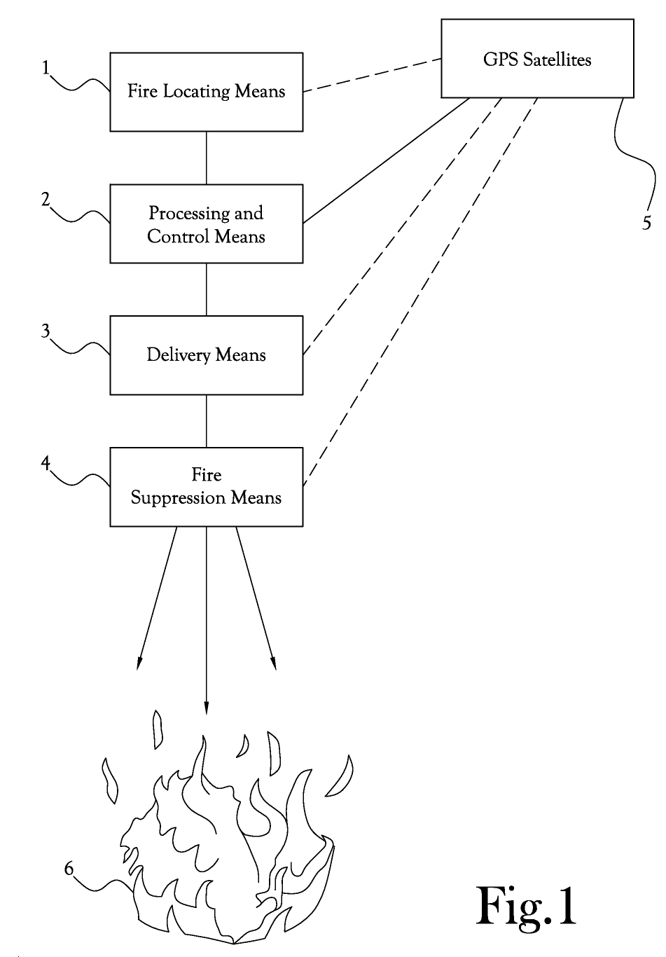

FIG. 1 illustrates one example embodiment of a forest fire control system configured to quickly locate, suppress, and extinguish a new forest fire 6 in the beginning stage. The forest fire control system is comprised of a fire locating means 1, a processing and control means 2, a delivery means 3, and a fire suppression means 4.

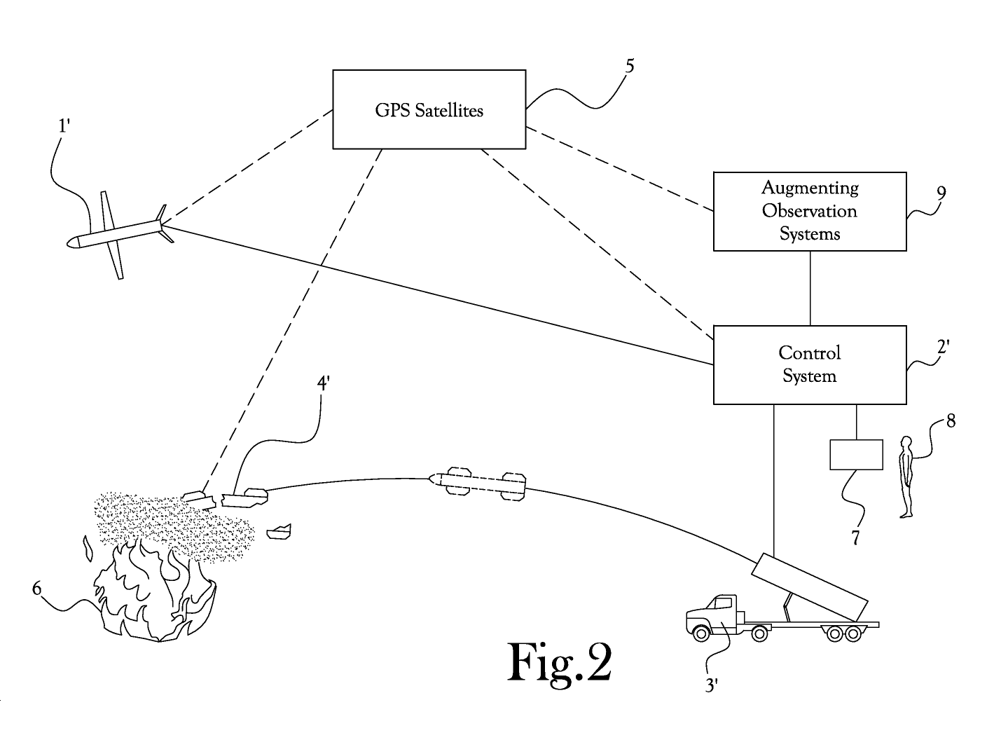

Referring to FIG. 1, the fire locating means 1 may utilize one or a combination of devices and technology to identify and determine the location coordinates for a new forest fire 6 utilizing a signal from a GPS satellite 5. The control means 2 is in communication with the fire locating means 1 and the delivery means 3; and the control means 2 is configured to receive the location coordinates and other information for a new forest fire 6, to process this information, to develop a proposed fire suppression response, and to control a delivery means 3. The delivery means 3 is in communication with the control means 2 and the fire suppression means 4; and the delivery means 3 is configured to deliver the fire suppression means 4 to the forest fire 6 under the direction and control of the control means 2 and utilizing a signal from a GPS satellite 5. The fire suppression means 4 is in communication with the control means 2 and the delivery means 3; and the fire suppression means 4 is configured to suppress and extinguish the forest fire 6. FIG. 2 is a diagram illustrating an example embodiment of a forest fire control system utilizing a drone, a ballistic missile delivery system and a GPS-guided missile containing a fire retarding chemical.

Referring to FIGS. 1 and 2, the preferred fire locating means 1 for the present general inventive concept is comprised of at least one unmanned drone 1′ controlled by a control system 2′ comprised of a computer with computer software applications and a human operator system combination. Each drone 1′ is configured with infrared detectors to detect and provide location coordinates for a new forest fire 6 utilizing a signal from a GPS satellite 5. A system of drones 1′ can provide complete and continuous coverage of selected fire risk areas. Observational systems that already exist and human communication of fire dangers and actual fires from commercial pilots and others can be included to augment the fire locating means 1, 1′. For example, an augmenting observational system 9 may be as simple as a ranger at a lookout station utilizing a GPS device configured to determine the location coordinates of the new forest fire 6 and communicating the location coordinates of the new forest fire 6 into the control system 2′. Some embodiments of the present general inventive concept may utilize a more complex augmenting observational system 9 to detect forest fires such as satellite imaging to monitor the forest for a new forest fire 6 and to communicate the existence and location of the new forest fire 6 to the control system 2′.

The control means 2 is configured to receive the location coordinates and other information for a new forest fire 6, to process this information, to develop a proposed fire suppression response and to control a delivery means. In one embodiment of the forest fire control system, the control system 2′ will be comprised of a computer with computer software applications configured to control the flight patterns of the drone 1′, to process information about the new forest fire 6 received from the drone 1′, to develop a proposed fire suppression response (including the type of fire retardant to be utilized), and to control a delivery means 3 (including the trajectory of the fire suppression means 4). Referring to FIG. 2, an operator 8 using the control system 2′ reviews the information about the new forest fire 6 and the proposed fire suppression response on the monitor of a computer terminal 7. The operator 8 makes a decision whether to approve the proposed fire suppression response or to override the proposed fire suppression response and substitute a different response. The operator 8 inputs an approval response or an override response into the computer terminal 7, and the computer of the control system 2′ initiates an appropriate command to the missile delivery system 3′.

In some embodiments of the present general inventive concept, the computer software application in the computer of the control system 2′ that develops the proposed fire suppression response is configured to take into account the type of burning material in the forest fire 6 (for example, grass, brush or large trees) in determining the most efficient type of fire retardant to be used on the forest fire 6. In addition, the computer software application in the computer of the control system 2′ that controls the missile delivery system 3′ is configured to take into account the terrain around the forest fire as well as the type of burning material in the forest fire 6 (for example, a lower delivery point for a grass fire and an elevated delivery point for a fire in tall trees in calculating the trajectory of the missile 4′.

The preferred delivery means 3 for the present general inventive concept is a GPS-guided ballistic missile system 3′ that can deliver a fire suppression means 4 directly to the forest fire 6. For example, military ballistic missile systems developed by Raytheon Missile Systems and BAE Systems Bofors are currently being used to deliver a GPS-guided munition to targets within a few hundred feet of friendly troops. This ballistic missile system can be modified to deliver fire retarding chemicals directly onto the forest fire 6. In some embodiments, the ballistic missile system 3′ may be in a fixed location. In other embodiments, the ballistic missile system 3′ may be mobile and mounted on a truck bed, requiring the computer software application in the control system 2′ that calculates the trajectory of the missile 4′ to take into account the GPS location of the truck carrying the missile 4′ as well as the GPS location of the forest fire 6.

The preferred fire suppression means 4 for the present general inventive concept is an extended-range guided missile 4′ containing liquid, foam or solid fire retarding chemicals. For example, Raytheon Missile Systems and BAE Systems Bofors have developed the M982 Excalibur, which is a 155 mm extended range guided missile. The M982 Excalibur missile is currently being used in military close support situations. This type of missile can be modified to accommodate and carry different types of fire retardants for differing types of fire situations. Referring to FIG. 2, the missile 4′ is a guided missile which has been modified to carry fire retarding chemicals. A guidance system in the missile 4′ stores the location coordinates of the forest fire 6, and the missile 4′ is in communication with the GPS satellite 5 to guide itself in the last phase of its trajectory. This improves the accuracy of the missile 4′ and delivers the fire retarding chemicals as close as possible to the forest fire 6.

In some embodiments, a longer range missile 4′ could be employed to reach a more distant forest fire 6. Delivery of missiles 4′ could continue until the forest fire 6 is extinguished or until larger, but slower, delivery systems now in use are in position to fight the forest fire 6. Firefighters and airplanes or helicopters with large volumes of fire retardant could be dispatched and utilized if necessary to fully extinguish the forest fire 6.

While the present invention has been illustrated by description of one or more embodiments and while the illustrative embodiments have been presented for the purposes of illustration and description, it is not the intention of the applicant to restrict or in any way limit the scope of the appended claims to such detail or such described embodiments. Additional modifications and variations will readily appear to those skilled in the art. The invention in its broader aspects is therefore not limited to the specific details, representative systems and methods, and illustrative examples shown and described. Accordingly, departures may be made from such details without departing from the spirit or scope of applicant's general inventive concept.

Having thus described the aforementioned invention, what is claimed is:

1. A system for locating, suppressing and extinguishing a forest fire in the beginning stage, comprising:
(a) a fire locating means configured to identify the existence and location of a new forest fire;
(b) a processing and control means configured to process information received from the fire locating means, to develop a proposed fire suppression response, and to control a delivery means;
(c) a delivery means configured to deliver a fire suppression means to the location of said fire; and
(d) a fire suppression means configured to suppress and extinguish said fire.

2. The system for locating, suppressing and extinguishing a forest fire in the beginning stage of claim 1 wherein said delivery configured to deliver a fire suppression means comprises a guided missile adapted to deliver fire retarding chemicals.

3. The system for locating, suppressing and extinguishing a forest fire in the beginning stage of claim 2 wherein guided missile is adapted to be guided by GPS signals.

4. The system for locating, suppressing and extinguishing a forest fire in the beginning stage of claim 1 wherein said fire suppression means is a fire retarding chemical.

5. The system for locating, suppressing and extinguishing a forest fire in the beginning stage of claim 1 wherein said fire locating means comprises an unmanned drone configured with infrared detectors for detecting and providing location coordinates of a fire to said processing and control means.

6. A method for locating, suppressing and extinguishing a forest fire in the beginning stage, comprising:
(a) identifying and locating a new forest fire;
(b) processing information received from the fire locating means, developing a proposed fire suppression response, and controlling a delivery means;
(c) delivering fire retardants to the location of said fire; and
(d) suppressing and extinguishing said fire.

7. The method for locating, suppressing and extinguishing a forest fire in the beginning stage of claim 6 wherein said delivery configured to deliver a fire suppression means comprises a guided missile adapted to deliver fire retarding chemicals.

8. The method for locating, suppressing and extinguishing a forest fire in the beginning stage of claim 7 wherein guided missile is adapted to be guided by GPS signals.

9. The system for locating, suppressing and extinguishing a forest fire in the beginning stage of claim 6 wherein said fire suppression means is a fire retarding chemical.

10. The method for locating, suppressing and extinguishing a forest fire in the beginning stage of claim 6 wherein said fire locating means comprises an unmanned drone configured with infrared detectors for detecting and providing location coordinates of a fire to said processing and control means.
